(19) United States
(12) Patent Application Publication
(10) Pub. No.: US 2011/0063270 A1
(43) Pub. Date: Mar. 17, 2011

(54) SOURCE DRIVER OF DISPLAY DEVICE, AND METHOD OF CONTROLLING THE SAME

(75) Inventor: Tadao MINAMI, Kanagawa (JP)

(73) Assignee: RENESAS ELECTRONICS CORPORATION, Kanagawa (JP)

(21) Appl. No.: 12/877,241

(22) Filed: Sep. 8, 2010

(30) Foreign Application Priority Data
Sep. 11, 2009 (JP) 2009-210478

(51) Int. Cl. G09G 5/00

(52) U.S. Cl. 345/208

(57) ABSTRACT

A source driver having a cascade connection configuration that drives signal lines of a display device according to a plurality of signals transmitted by a mini-LVDS interface from a controller during a predetermined period corresponding to a cascade signal received from a preceding stage, the source driver including a first reception circuit receiving a first signal of the plurality of signals; a second reception circuit receiving a second signal of the plurality of signals; and an enable control circuit that controls each of the first and second reception circuits to one of an active state and a standby state; in which the enable control circuit sets the second reception circuit to the active state according to the cascade signal received from the preceding stage, and sets the first and second reception circuits to the standby state according to a cascade signal output by the source driver to a subsequent stage.

### INCORPORATION BY REFERENCE

This application is based upon and claims the benefit of priority from Japanese patent application No. 2009-210478, filed on Sep. 11, 2009, the disclosure of which is incorporated herein in its entirety by reference.

### BACKGROUND

1. Field of the Invention

The present invention relates to a source driver of a display device and a method of controlling the same.

2. Description of Related Art

Recently, plane display devices such as a liquid crystal display have been increased in size. A large-scale plane display device drives signal lines by using an IC (Integrated Circuit) that is called a source driver. The number of signal lines that can be driven by each source driver has the limit. The plane display device that is enlarged and is highly miniaturized has plural source drivers that have a cascade connection configuration as shown in FIG. 6. The plane display device sequentially operates plural source drivers, and drives all signal lines for one horizontal line.

As shown in FIG. 6, a plane display device 1 of a related art includes a controller 10, source drivers IC1 to IC4, and a display 12. The controller 10 transmits a clock signal CLK, a loading signal LOAD, and data signals DD0 to DD5 to each of source drivers. The clock signal CLK is a signal to generate the operation clock of source drivers IC1 to IC4. Data signals DD0 to DD5 are pixel data. Each of source drivers IC1 to IC4 outputs a pixel drive signal corresponding to data signals DD0 to DD5 to the display 12. The loading signal LOAD is a strobe signal to sequentially take data signals DD0 to DD5 into each of source drivers IC1 to IC4. This loading signal LOAD is output to source drivers IC1 to IC4 from the controller 10 for every horizontal period. In the example of FIG. 6, the number of source drivers is limited to four for the simplification of the drawing. However, a further number of source drivers may be used.

Each of source drivers receives the clock signal CLK, the loading signal LOAD, and data signals DD0 to DD5. Each of source drivers sequentially latches data signals DD0 to DD5 that are pixel data. The latch operation of each of source drivers is done according to a cascade signal DOI from a preceding stage. The source driver IC1 receives a logical signal of high level from a power-supply voltage terminal VDD as the cascade signal DOI of the preceding stage.

As mentioned above, the plane display device has been enlarged and highly miniaturized, and then the number of pixels of one horizontal line has been increasing. Therefore, a high-speed forwarding of the data signal and the like that is transmitted between the controller and each source driver is needed. In a liquid crystal display, mini-LVDS is generally used as an interface for a high-speed forwarding between this controller and each source driver. The interface standard of this mini-LVDS exchanges data and clock signals between a transmitting circuit and a reception circuit with LVDS (Low voltage differential signaling) shown in FIG. 7.

As shown in FIG. 7, the controller 10 includes a transmitting circuit Tx, and each of source drivers IC1 to IC4 includes a reception circuit Rx. FIG. 7 only shows the controller 10 and the source driver IC1. The transmitting circuit Tx and the reception circuit Rx are connected with signal buses LVDS+ and LVDS−. A differential signal is transmitted to the signal buses LVDS+ and LVDS−. The transmitting circuit Tx allows current to flow between the signal bus LVDS+, a terminator resistor R1, and the signal bus LVDS−. Then, the reception circuit Rx decides a logical value of the reception signal according to a polarity of potential difference caused at both ends of the terminator resistor R1. In such circuit configuration, noise reduction such as EMI (Electro Magnetic Interference) is possible with a coupling between the signal buses LVDS+ and LVDS−.

FIG. 8 shows a block diagram of each of source drivers IC1 to IC4. The source drivers IC1 to IC4 have basically similar the configuration, and thus only the configuration of the source driver IC1 will be explained below. The source driver IC1 includes reception circuits RxDD0 to RxDD5, RxCLK, an enable control circuit 21, a divide-by-4 frequency divider 22, a DOI signal generation circuit 23 and a data register 24.

Each of reception circuits RxDD0 to RxDD5, and RxCLK receives VLDS signal from the controller 10 similarly to the reception circuit Rx of FIG. 7. Reception circuits RxDD0 to RxDD5 and RxCLK receive data signals DD0 to DD5 and the clock signal CLK that are VLDS signals, respectively. Signals received by reception circuits RxDD0 to RxDD5 and RxCLK are converted to CMOS signal level and are output to circuits provided at the subsequent stage.

The enable control circuit 21 controls reception circuits RxDD0 to RxDD5 and RxCLK to be in an active state or a standby state according to an enable signal REC_EN. The configuration of the enable control circuit 21 is described later.

The divide-by-4 frequency divider 22 divides frequency of a clock signal of CMOS signal level output by the reception circuit RxCLK by four. The clock signal CLK whose frequency is divided by four is used as an internal operation clock of the source driver IC1. Thus the source driver IC1 decreases power consumption. Hereinafter, the clock signal whose frequency is divided by four is called an internal operation clock signal. The active state or the standby state of the divide-by-4 frequency divider 22 is controlled according to the enable signal REC_EN of the enable control circuit 21.

Upon receiving a cascade signal DIO of high level, the DOI signal generation circuit 23 outputs the cascade signal DOI of high level for a predetermined period after a predetermined number of clocks. The DOI signal generation circuit 23 includes a shift register 30. The shift register 30 counts the clock signal CLK that is output by the reception circuit RxCLK for predetermined number of clocks. One example of the operation of the DOI signal generation circuit 23 will be briefly explained below.

When the cascade signal DIO of high level is received, the DOI signal generation circuit 23 makes the shift register 30 start to count the number of clocks of the clock signal CLK. Then, when the shift register 30 counts the predetermined number of clocks, the DOI signal generation circuit 23 outputs the cascade signal DOI of high level for a predetermined period. The predetermined period in which this cascade signal DOI keeps the high level corresponds to, for instance, one cycle of the operation clock.

Here, the configuration of the enable control circuit 21 is shown in FIG. 9. As shown in FIG. 9, the enable control circuit 21 includes delay circuits DLY1, DLY2, a NAND circuit NAND1, a NOR circuit NOR1, an inverter circuit IV1, and an RS latching circuit RS1.

The delay circuit DLY1 includes inverter circuits IV11 to IV13. The inverter circuits IV11 to IV13 that are sequentially connected with series constitute an inverter chain. The inverter circuit IV11 of the first stage receives the loading signal LOAD. Then, the inverter circuit IV13 of the final stage outputs the loading signal LOAD delayed for a predetermined period.

The NAND circuit NAND1 has one input terminal to which the loading signal LOAD is input, and the other input terminal to which the loading signal LOAD delayed for the predetermined period output by the inverter circuit IV13 is input. The NAND circuit NAND1 outputs an operation result to the inverter circuit IV1. The inverter circuit IV1 inverts the output signal of the NAND circuit NAND1, and outputs the inverted signal as a REC_SET signal. Therefore, the REC_SET signal is a pulse signal that is in the high level by an amount of delay generated in the delay circuit DLY1 from the rising edge of the loading signal LOAD.

The delay circuit DLY2 includes inverter circuits IV21 to IV23. The inverter circuits IV21 to IV23 that are sequentially connected with series constitute an inverter chain. The inverter circuit IV21 of the first stage receives the cascade signal DOI. Then, the inverter circuit IV23 of the final stage outputs the cascade signal DOI delayed for a predetermined period.

The NOR circuit NOR1 has one terminal to which the cascade signal DOI is input, and the other input terminal to which the cascade signal DOI delayed for the predetermined period output by the inverter circuit IV23 is input. The NOR circuit NOR1 outputs an operation result as a REC_RSET signal. Therefore, the REC_RSET signal is a pulse signal that is in the high level by an amount of delay generated in the delay circuit DLY2 from the falling edge of the cascade signal DOI.

The RS latching circuit RS1 has a set terminal S to which the REC_SET signal is input, and has a reset terminal R to which the REC_RSET signal is input. Then, the RS latching circuit RS1 outputs an enable signal REC_EN according to the REC_SET signal and the REC_RSET signal. In detail, when receiving the REC_SET signal of high level, the RS latching circuit RS1 outputs the enable signal REC_EN of high level from an output terminal Q. Alternatively, when receiving the REC_RSET signal of high level, the RS latching circuit RS1 outputs the enable signal REC_EN of low level from the output terminal Q.

FIG. 10 shows a circuit configuration of reception circuits RxDD0 to RxDD5 and RxCLK. The reception circuits RxDD0 to RxDD5 and RxCLK have basically the similar configuration, and thus only the configuration of the reception circuit RxDD0 will be explained below. As shown in FIG. 10, the reception circuit RxDD0 includes PMOS transistors MP1 to MP6, NMOS transistors MN1 to MN8, a NAND circuit NAND31, an inverter circuit IV31, and a current supply CC31.

A differential stage is composed of the current supply CC31 and PMOS transistors MP1 and MP2, and the NMOS transistor MN1. The differential stage receives the LVDS signal. An amplifying stage is composed of PMOS transistors MP3 to MP6 and NMOS transistors MN5 to MN8. The amplifying stage amplifies the signal that is output from the above-mentioned differential stage.

When the enable signal REC_EN is in the high level, the LVDS signal becomes a signal at CMOS level and it is output from the reception circuit RxDD0. On the other hand, when the enable signal REC_EN is in the low level, NMOS transistors MN1 to MN4 interrupt current pathways between a power-supply voltage terminal VDD and a voltage terminal VSS. Further, an output of the NAND circuit NAND31 is fixed to the high level by the enable signal REC_EN of low level. Therefore, an output of the inverter circuit IV31, which is the output of the reception circuit RxDD0 is fixed to the low level and the reception circuit RxDD0 is in the standby state. Accordingly, the active state or the standby state of the reception circuit RxDD0 is controlled according to the enable signal REC_EN.

FIGS. 11 to 13 show timing charts that show operation of source drivers IC1 to IC4. Note that the same reference symbols of time in FIGS. 11 to 13 indicate the same time. In addition, it is assumed that reception circuits RxCLK and RxDD0 to RxDD5 of all source drivers are in the standby state before time t1.

The loading signal LOAD of high level is received by source drivers IC1 to IC4 at time t1. In the enable control circuit 21 of each of source drivers, the REC_SET signal of a pulse signal is generated according to the rising edge of this loading signal LOAD. The enable signal REC_EN of high level is output from the RS latching circuit RS1 according to this REC_SET signal. Then, reception circuits RxCLK and RxDD0 to RxDD5 of each of source drivers enter the active state according to this enable signal REC_EN.

All source drivers receive data signal DD0 of high level as reset data RST at time t2. In a mini-LVDS interface, after the reception circuit Rx enters active state, the data signal DD0 that is in the high level is set to the reset data RST for four cycles of the clock signal CLK (period T1).

After receiving the reset data RST, the divide-by-4 frequency divider 22 outputs the internal operation clock signal at time t3 in each of all source drivers. Each source driver operates according to this internal operation clock signal. Because the cascade signal DIO is in the high level, the source driver IC1 starts taking data of data signals DD0 to DD5 at timings of rising and falling edges of the clock signal CLK. Here, because the data is taken according to timings of rising and falling edges of the clock signal CLK as mentioned above, the data of eight bits is taken into the source driver IC1 in each one cycle of the internal operation clock for each data signal line.

Here, when (m×6)/8 pixel signal lines (m is a multiple of four) are driven for each one source driver, data taking of this one source driver is completed at the m-th edge timing of the clock signal CLK. Therefore, the source driver IC1 takes data of data signals DD0 to DD5 at each edge of the clock signal CLK between the edge of the clock signal CLK at time t3 (the first edge) and the edge of the clock signal CLK at time t5 (the m-th edge).

The shift register 30 of the source driver IC1 counts the (m−3)-th edge of the clock signal CLK at time t4. Then, the shift register 30 informs the DOI signal generation circuit 23 that the count reaches the predetermined number. Then, at this timing the DOI signal generation circuit 23 of the source driver IC1 raises the cascade signal DOI to the high level. Note that the cascade signal DOI of this source driver IC1 is the cascade signal DIO of the source driver IC2.

At time t7 after one cycle of the internal operation clock from time t4, the DOI signal generation circuit 23 of the source driver IC1 lowers the cascade signal DOI to the low level. In addition, the REC_RSET signal of a pulse signal is generated by the enable control circuit 21 of the source driver IC1 according to this falling edge. The enable signal REC_EN of low level is output from the RS latching circuit RS1 according to this REC_RSET signal. Then, reception circuits RxCLK and RxDD0 to RxDD5 of the source driver IC1 enter the standby state according to this enable signal REC_EN of low level. Moreover, the divide-by-4 frequency divider 22 that generates the internal operation clock enters the standby state, too. Therefore, the source driver IC1 enters the standby state.

On the other hand, the source driver IC2 that receives the cascade signal DIO of high level starts to take data of data signals DD0 to DD5 at each edge of the clock signal CLK from the rising edge of the internal operation clock at time t6. Note that the edge of the clock signal CLK at time t6 is (m+1)-th edge. Therefore, the source driver IC2 takes data of data signals DD0 to DD5 at each edge of the clock signal CLK between the edge of the clock signal CLK at time t6 (the (m+1)-th edge) and the edge of the clock signal CLK at time t9 (the 2 m-th edge). At the same time, the shift register 30 of the source driver IC2 starts to count the edge of the clock signal CLK at time t6.

The shift register 30 of the source driver IC2 counts the (m−3)-th edge of the clock signal CLK at time t8. Then, the shift register 30 informs the DOI signal generation circuit 23 that the count reaches the predetermined number. Then, at this timing the DOI signal generation circuit 23 of the source driver IC2 raises the cascade signal DOI to the high level. The cascade signal DOI of this source driver IC2 is the cascade signal DIO of the source driver IC3.

At time t11 after one cycle of the internal operation clock from time t8, the DOI signal generation circuit 23 of the source driver IC2 lowers the cascade signal DOI to the low level. In addition, the REC_RSET signal of a pulse signal is generated by the enable control circuit 21 of the source driver IC2 according to this falling edge. The enable signal REC_EN of low level is output from the RS latching circuit RS1 according to this REC_RSET signal. Then, reception circuits RxCLK and RxDD0 to RxDD5 of the source driver IC2 enter the standby state according to this enable signal REC_EN of low level. Moreover, the divide-by-4 frequency divider 22 that generates the internal operation clock enters the standby state, too. Therefore, the source driver IC2 enters the standby state.

After this, source drivers IC3 and IC4 perform the similar operation as described above. More specifically, the source driver IC3 that receives the cascade signal DIO of high level starts to take data of data signals DD0 to DD5 at each edge of the clock signal CLK from the rising edge of the internal operation clock at time t10. Note that the edge of the clock signal CLK at time t10 is (2 m+1)-th edge. Therefore, the source driver IC3 takes data of data signals DD0 to DD5 at each edge of the clock signal CLK between the edge of the clock signal CLK at time t10 (the (2 m+1)-th edge) and the edge of the clock signal CLK at time t13 (the 3m-th edge). At the same time, the shift register 30 of the source driver IC3 starts to count the edge of the clock signal CLK at time t10.

The shift register 30 of the source driver IC3 counts the (m−3)-th edge of the clock signal CLK at time t12. Then, the shift register 30 informs the DOI signal generation circuit 23 that the count reaches the predetermined number. Then, at this timing the DOI signal generation circuit 23 of the source driver IC3 raises the cascade signal DOI to the high level. The cascade signal DOI of this source driver IC3 is the cascade signal DIO of the source driver IC4.

At time t15 after one cycle of the internal operation clock from time t12, the DOI signal generation circuit 23 of the source driver IC3 lowers the cascade signal DOI to the low level. In addition, the REC_RSET signal of a pulse signal is generated by the enable control circuit 21 of the source driver IC3 according to this falling edge. The enable signal REC_EN of low level is output from the RS latching circuit RS1 according to this REC_RSET signal. Then, reception circuits RxCLK and RxDD0 to RxDD5 of the source driver IC3 enter the standby state according to this enable signal REC_EN of low level. Moreover, the divide-by-4 frequency divider 22 that generates the internal operation clock enters the standby state, too. Therefore, the source driver IC3 enters the standby state.

The source driver IC4 that receives the cascade signal DIO of high level starts to take data of data signals DD0 to DD5 at each edge of the clock signal CLK from the rising edge of the internal operation clock at time t14. Note that the edge of the clock signal CLK at time t14 is (3 m+1)-th edge. Therefore, the source driver IC4 takes data of data signals DD0 to DD5 at each edge of the clock signal CLK between the edge of the clock signal CLK at time t14 (the (3 m+1)-th edge) and the edge of the clock signal CLK at time t17 (the 4m-th edge). At the same time, the shift register 30 of the source driver IC4 starts to count the edge of the clock signal CLK at time t14.

The shift register 30 of the source driver IC4 counts the (m⁻³)-th edge of the clock signal CLK at time t16. Then, the shift register 30 informs the DOI signal generation circuit 23 that the count reaches the predetermined number. Then, at this timing the DOI signal generation circuit 23 of the source driver IC4 raises the cascade signal DOI to the high level. The cascade signal DOI of this source driver IC4 is the cascade signal DIO of a source driver of the subsequent stage.

At time t19 after one cycle of the internal operation clock from time t16, the DOI signal generation circuit 23 of the source driver IC4 lowers the cascade signal DOI to the low level. In addition, the REC_RSET signal of a pulse signal is generated by the enable control circuit 21 of the source driver IC4 according to this falling edge. The enable signal REC_EN of low level is output from the RS latching circuit RS1 according to this REC_RSET signal. Then, reception circuits RxCLK and RxDD0 to RxDD5 of the source driver IC4 enter the standby state according to this enable signal REC_EN of low level. Moreover, the divide-by-4 frequency divider 22 that generates the internal operation clock enters the standby state, too. Therefore, the source driver IC4 enters the standby state.

A technology of a liquid crystal display device that includes source drivers having a cascade connection configuration is disclosed in Japanese Unexamined Patent Application Publication No. 2005-284217.

### SUMMARY

The present inventor has found a problem as described below. In the plane display device 1 of the related art, the reception circuits RxCLK and RxDD0 to RxDD5 of source drivers IC1 to IC4 are in the active state from time t1 as shown in FIG. 11 to FIG. 13. This is due to the fact that reception circuits RxDD0 and RxCLK which receive the clock signal CLK and the reset data RST of each of source drivers enter the active state at time t1 in the mini-LVDS interface standard.

However, source drivers IC1 to IC4 that are connected with cascade connection need not make reception circuits RxDD1 to RxDD5 active other than reception circuits RxDD0 and RxCLK until the cascade signal DIO of high level is received. Therefore, in reception circuits RxDD1 to RxDD5, unnecessary power is consumed. Moreover, even if a source driver is in the standby state, power consumption of the source driver keeps increasing in a liquid crystal display device or the like that is enlarged and highly miniaturized. Therefore, it is necessary to reduce wasting power consumption as mentioned above for the decrease of power consumption of source drivers.

A first exemplary aspect of an embodiment of the invention is a source driver having a cascade connection configuration that drives signal lines of a display device according to a plurality of signals transmitted by a mini-LVDS interface from a controller during a predetermined period corresponding to a cascade signal received from a preceding stage, the source driver including: a first reception circuit that receives a first signal of the plurality of signals; a second reception circuit that receives a second signal of the plurality of signals; and an enable control circuit that controls each of the first reception circuit and the second reception circuit to one of an active state and a standby state; in which the enable control circuit sets the second reception circuit to the active state according to the cascade signal received from the preceding stage, and sets the first and second reception circuits to the standby state according to a cascade signal output by the source driver to a subsequent stage.

The source driver in accordance with an exemplary aspect of the present invention sets the second reception circuit to the active state according to the cascade signal received from the preceding stage. Then the source driver sets the second reception circuit to the standby state according to the cascade signal output by the source driver to the subsequent stage. Therefore, the second reception circuit can enter the standby state during a period in which the second reception circuit needs not enter the active state in the source driver that has a cascade connection configuration. Then, power consumption in the source driver can be reduced during the period in which the second reception circuit needs not enter the active state.

The power consumption can be reduced according to the source driver in accordance with the exemplary aspect of the present invention.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is an example of a configuration of a source driver in accordance with an exemplary embodiment of the present invention;

FIG. 2 is an example of a configuration of an enable control circuit of the source driver in accordance with the exemplary embodiment of the present invention;

FIG. 3 is a timing chart for explaining operations of a display device in accordance with the exemplary embodiment of the present invention;

FIG. 4 is a timing chart for explaining operations of the display device in accordance with the exemplary embodiment of the present invention;

FIG. 5 is a timing chart for explaining operations of the display device in accordance with the exemplary embodiment of the present invention;

FIG. 6 is a configuration of a general display device;

FIG. 7 is a schematic diagram to explain an LVDS interface.

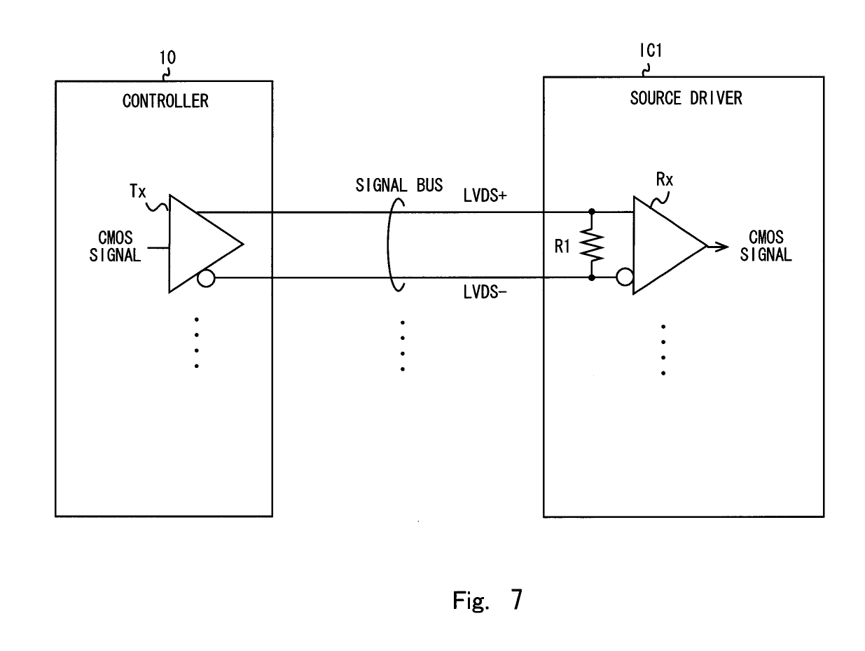

FIG. 8 is a configuration of a source driver of a related art;

FIG. 9 is a configuration of an enable control circuit of the source driver of the related art;

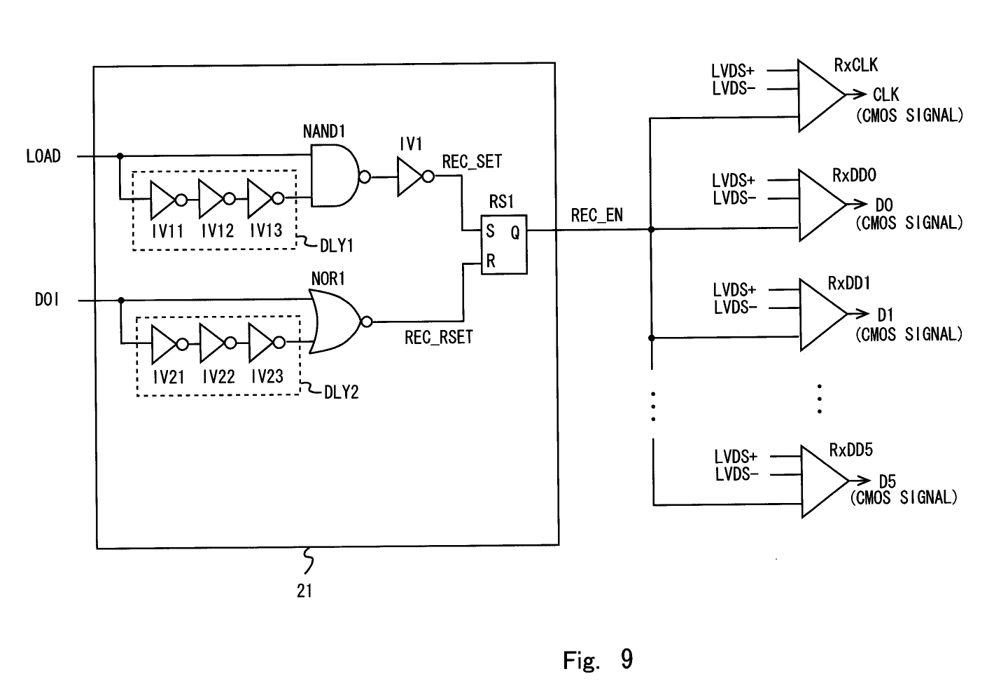

FIG. 10 is a circuit configuration of a reception circuit.

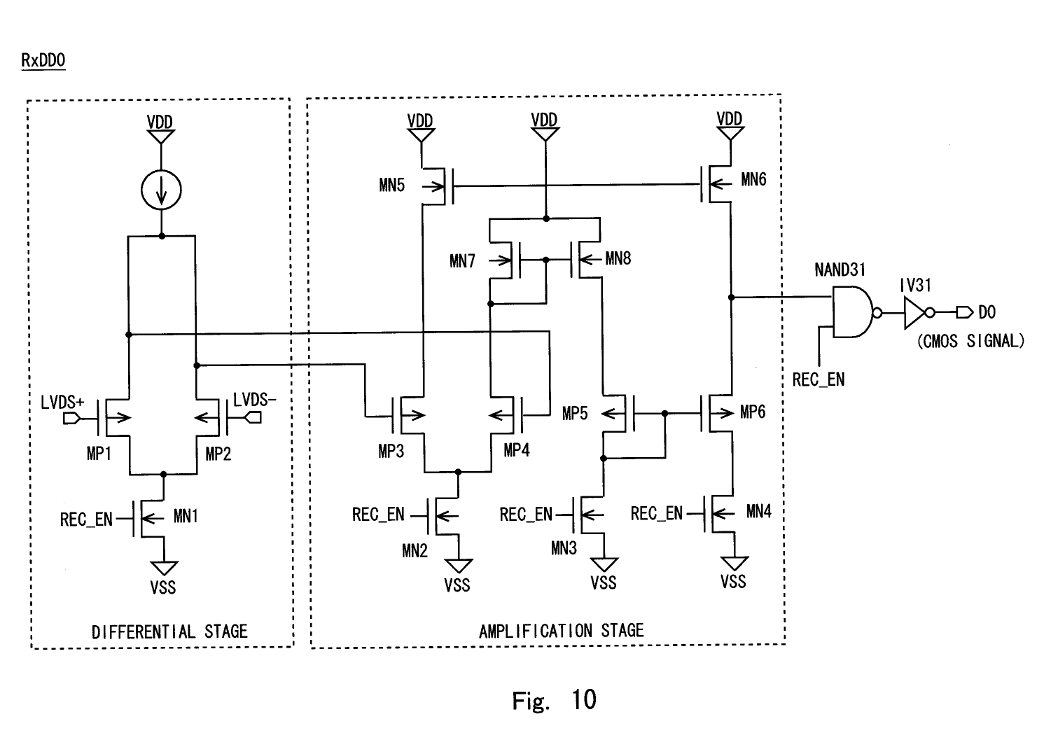

FIG. 11 is a timing chart for explaining operations of a display device of a related art;

FIG. 12 is a timing chart for explaining operations of the display device of the related art; and

FIG. 13 is a timing chart for explaining operations of the display device of the related art;

### DETAILED DESCRIPTION OF THE EXEMPLARY EMBODIMENTS

### Exemplary Embodiment

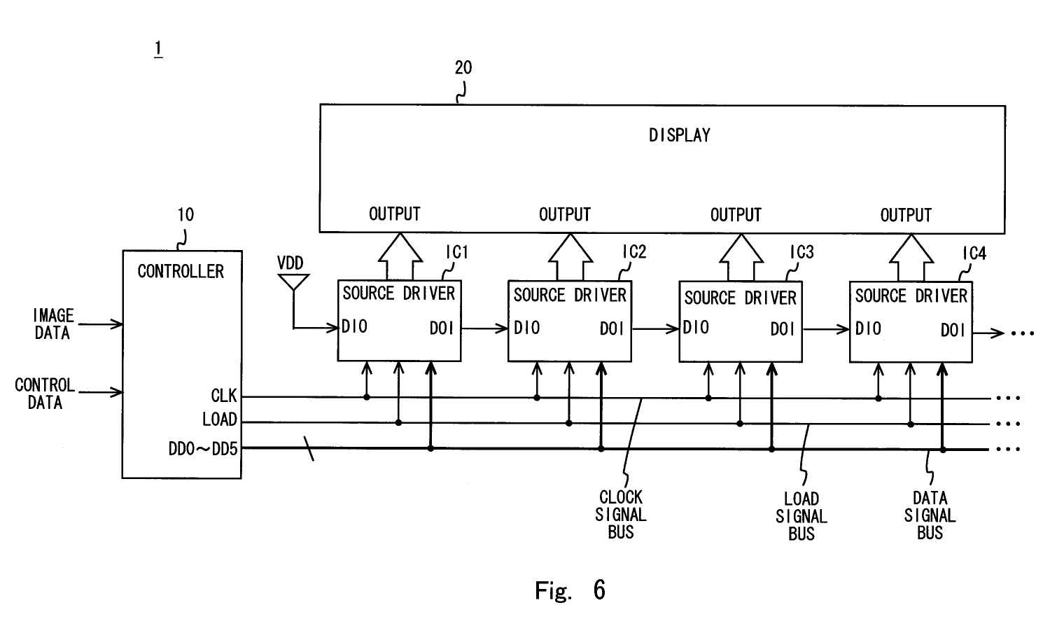

A specific exemplary embodiment of the present invention is explained hereinafter with reference to the drawings. In this exemplary embodiment, the present invention is applied to source drivers IC1 to IC4 of a liquid crystal display device. Note that a block configuration of the liquid crystal display device of this exemplary embodiment is similar to that shown in FIG. 6, and therefore explanation of the configuration thereof is omitted here. Therefore, source drivers IC1 to IC4 in FIG. 6 are replaced by source drivers IC1 to IC4 in this exemplary embodiment.

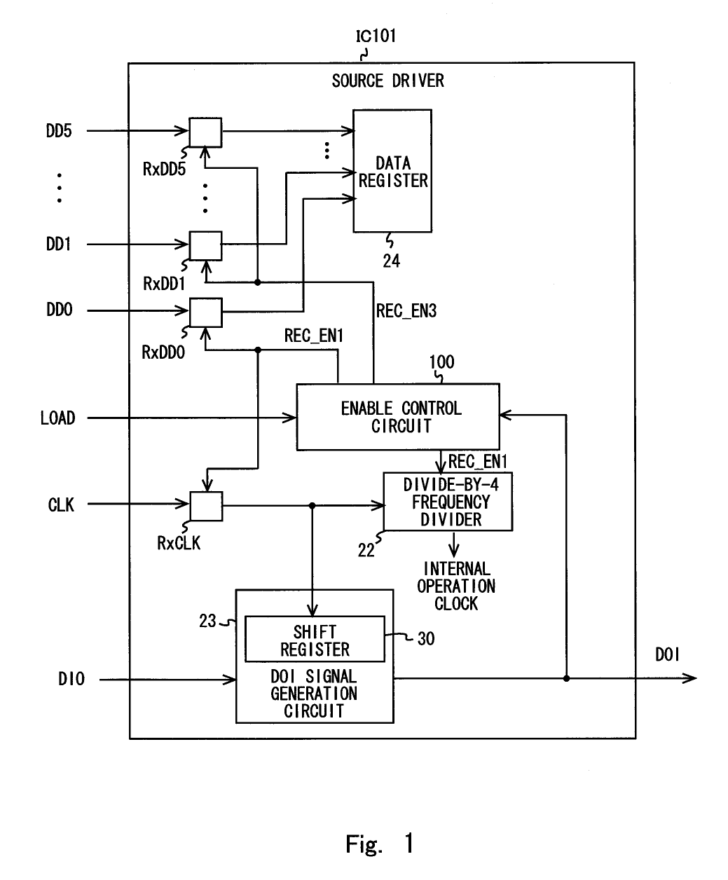

FIG. 1 shows a block diagram of source drivers IC1 to IC4. Note that the source drivers IC1 to IC4 have the similar configuration. Therefore, only a configuration of the source driver IC1 will be explained in the following description.

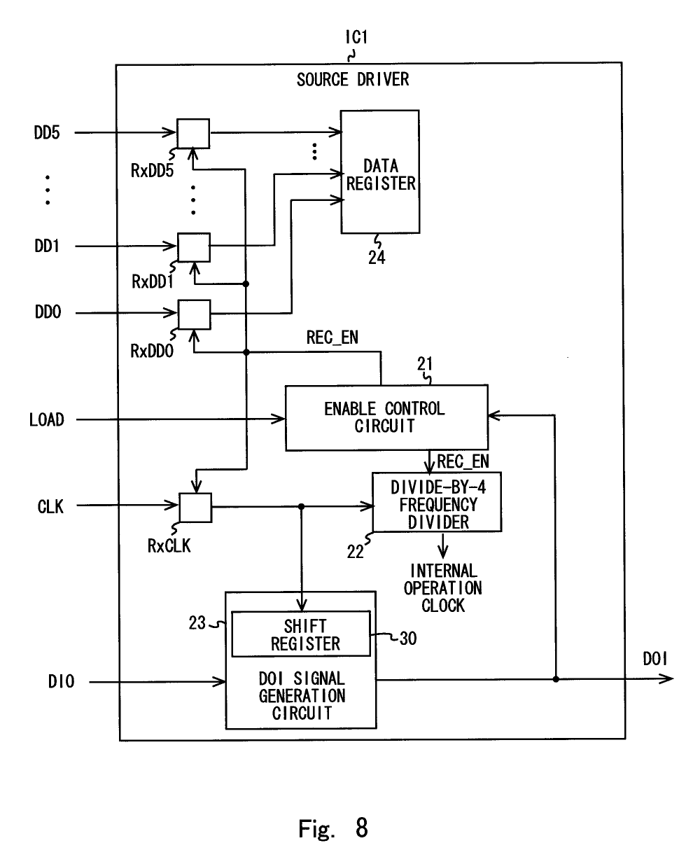

As shown in FIG. 1, the source driver IC1 includes reception circuits RxDD0 to RxDD5, and RxCLK, an enable control circuit 100, a divide-by-4 frequency divider 22, a DOI signal generation circuit 23 and a data register 24. In FIG. 1, the configurations denoted by the same reference symbols as in FIG. 8 indicate the same or similar configurations as those therein. The enable control circuit 100 is different between the source driver IC1 of FIG. 1 and the source driver IC1 of FIG. 8. Thus the above different point is mainly described in this exemplary embodiment.

As shown in FIG. 1, enable signals REC_EN1 and REC_EN3 described later are output from the enable control circuit 100. The enable signal REC_EN1 is supplied to reception circuits RxCLK and RxDD0. The enable signal REC_EN3 is supplied to reception circuits RxDD1 to RxDD5. Hereinafter, the enable control circuit 100, which is a feature part of this invention, is mainly described in this exemplary embodiment.

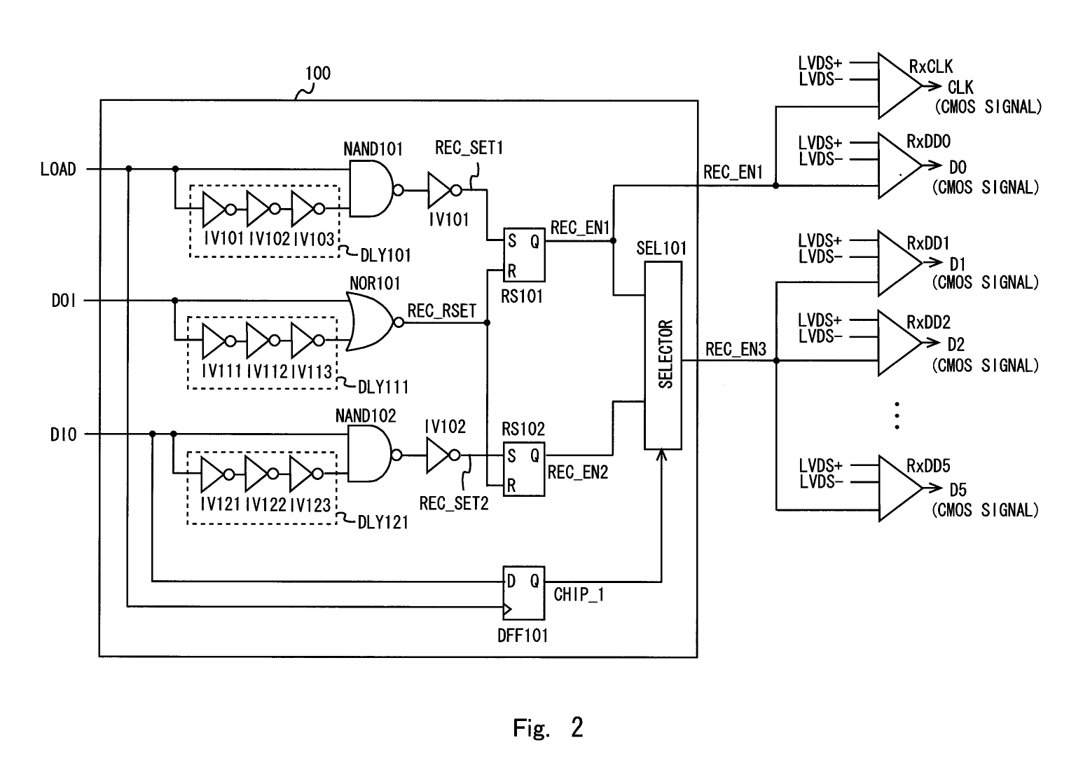

FIG. 2 shows the configuration of the enable control circuit 100. As shown in FIG. 2, the enable control circuit 100 includes delay circuits DLY101, DLY111 and DLY121, NAND circuits NAND101 and 102, a NOR circuit NOR101, inverter circuits IV101 and IV102, RS latching circuits RS101 and RS102, a D flip-flop DFF101, and a selector SEL101.

The delay circuit DLY101 includes inverter circuits IV101 to IV103. The inverter circuits IV101 to IV103 that are sequentially connected with series constitute an inverter chain. The inverter circuit IV101 of the first stage receives a loading signal LOAD. Then, the inverter circuit IV103 of the final stage outputs the loading signal LOAD delayed for a predetermined period.

The NAND circuit NAND has one input terminal to which the loading signal LOAD is input, and the other input terminal to which the loading signal LOAD delayed for the predetermined period output by the inverter circuit IV103 is input. The NAND circuit NAND outputs an operation result to the inverter circuit IV101. The inverter circuit IV101 inverts the output signal of the NAND circuit NAND101, and outputs the inverted signal as a REC_SET1 signal. Therefore, the REC_SET1 signal is a pulse signal that is in high level by an amount of delay generated in the delay circuit DLY101 from the rising edge of the loading signal LOAD.

The delay circuit DLY111 includes inverter circuits IV111 to IV113. The inverter circuits IV111 to IV113 that are sequentially connected with series constitute an inverter chain. The inverter circuit IV111 of the first stage receives a cascade signal DOI. Then, the inverter circuit IV113 of the final stage outputs the cascade signal DOI delayed for a predetermined period.

The NOR circuit NOR101 has one input terminal to which the cascade signal DOI is input, and the other input terminal to which the cascade signal DOI delayed for the predetermined period output by the inverter circuit IV113 is input. The NOR circuit NOR101 outputs an operation result as a REC_RSET signal. Therefore, the REC_RSET signal is a pulse signal that is in the high level by an amount of delay generated in the delay circuit DLY111 from the falling edge of the cascade signal DOI.

The delay circuit DLY121 includes inverter circuits IV121 to IV123. The inverter circuits IV121 to IV123 that are sequentially connected with series constitute an inverter chain. The inverter circuit IV121 of the first stage receives a cascade signal DIO. Then, the inverter circuit IV123 of the final stage outputs the cascade signal DIO delayed for a predetermined period.

The NAND circuit NAND102 has one input terminal to which the cascade signal DIO is input, and the other input terminal to which the cascade signal DIO delayed for the predetermined period output by the inverter circuit IV123 is input. The NAND circuit NAND102 outputs an operation result to the inverter circuit IV102. The inverter circuit IV102 inverts the output signal of the NAND circuit NAND102, and outputs the inverted signal as a REC_SET2 signal. Therefore, the REC_SET2 signal is a pulse signal that is in the high level by an amount of delay generated in the delay circuit DLY121 from the rising edge of the cascade signal DIO.

The RS latching circuit RS101 has a set terminal S to which the REC_SET1 signal is input, and has a reset terminal R to which the REC_RSET signal is input. Then, the RS latching circuit RS101 outputs an enable signal REC_EN1 according to the REC_SET1 signal and the REC_RSET signal. In detail, when receiving the REC_SET1 signal of high level, the RS latching circuit RS101 outputs the enable signal REC_EN1 of high level from an output terminal Q. When receiving the REC_RSET signal of high level, the RS latching circuit RS101 outputs the enable signal REC_EN1 of low level from the output terminal Q.

The RS latching circuit RS102 has a set terminal S to which the REC_SET2 signal is input, and has a reset terminal R to which the REC_RSET signal is input. Then, the RS latching circuit RS102 outputs an enable signal REC_EN2 according to the REC_SET2 signal and the REC_RSET signal. In detail, when receiving the REC_SET2 signal of high level, the RS latching circuit RS102 outputs the enable signal REC_EN2 of high level from the output terminal Q. When receiving the REC_RSET signal of high level, the RS latching circuit RS102 outputs the enable signal REC_EN2 of low level from the output terminal Q.

The D flip-flop DFF101 has a data input terminal D to which the cascade signal DIO is input, and a clock input terminal to which the loading signal LOAD is input. The D flip-flop DFF101 latches the cascade signal DIO according to the rising edge of the loading signal LOAD. Then, the value that the D flip-flop DFF101 latches is output from a data output terminal Q as a CHIP_{—}1 signal.

Because the cascade signal DIO is always in the high level (power-supply voltage VDD), the D flip-flop DFF101 of the source driver IC1 outputs a CHIP_{—}1 signal of high level according to a timing that the loading signal LOAD is raised up to high level. The D flip-flop DFF101 of each of source drivers IC2 to IC4 outputs a CHIP_{—}1 signal of low level at a timing that the loading signal LOAD is raised up to high level because the cascade signal DIO is in the low level.

The selector SEL101 has one input terminal to which the enable signal REC_EN1 is input, and the other input terminal to which the enable signal REC_EN2 is input. Then, the selector SEL101 selects one of enable signals REC_EN1 and REC_EN2, and outputs the select signal as the enable signal REC_EN3. In detail, when the CHIP_{—}1 signal is in the high level (the value is “1”), the enable signal REC_EN1 is output as the enable signal REC_EN3. Alternatively, when the CHIP_{—}1 signal is in the low level (the value is “0”), the enable signal REC_EN2 is output as the enable signal REC_EN3. As described above, it is only the source driver IC1 that the CHIP_{—}1 signal is in the high level. Therefore, only the source driver IC1 outputs the enable signal REC_EN1 as the enable signal REC_EN3. In the other source drivers IC2 to IC4, the enable signal REC_EN2 is outputs as the enable signal REC_EN3.

As mentioned above, the enable control circuit 100 outputs enable signals REC_EN1 and REC_EN3. Reception circuits RxCLK and RxDD0 receive the enable signal REC_EN1, and reception circuits RxDD1 to RxDD5 receive the enable signal REC_EN3. Therefore, an active state and a standby state of reception circuits RxCLK and RxDD0 are controlled according to the enable signal REC_EN1. Further, an active state and a standby state of reception circuits RxDD1 to RxDD5 are controlled according to the enable signal REC_EN3.

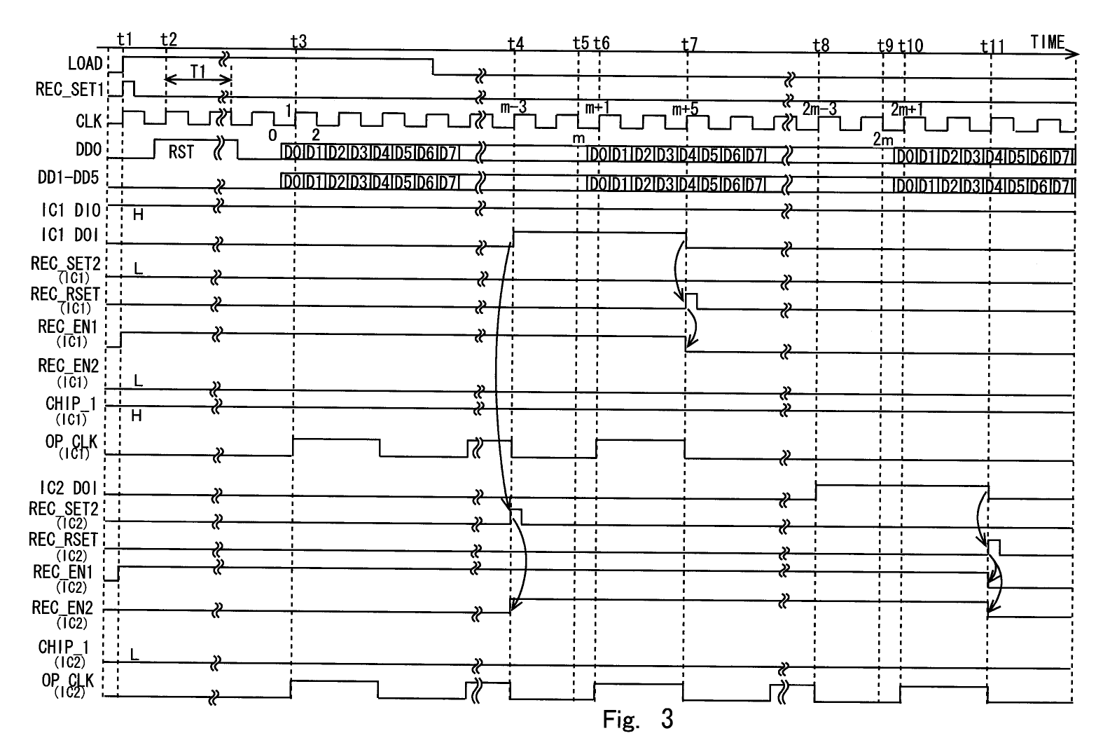

FIG. 3 to FIG. 5 show timing charts that show the operation of source drivers IC1 to IC4 that include the enable control circuit 100 in this exemplary embodiment. Note that the same reference symbols of time in FIGS. 3 to 5 indicate the same time. In addition, it is assumed that reception circuits RxCLK and RxDD0 to RxDD5 of all source drivers are in the standby state before time t1.

The loading signal LOAD of high level is received by source drivers IC1 to IC4 at time t1. In the enable control circuit 100 of each of source drivers, the REC_SET1 signal of a pulse signal is generated according to the rising edge of this loading signal LOAD. The enable signal REC_EN1 of high level is output from the RS latching circuit RS101 according to the REC_SET1 signal. Then, reception circuits RxCLK and RxDD0 of each of all source drivers enter the active state according to this enable signal REC_EN1.

Moreover, the CHIP_{—}1 of the source driver IC1 is in the high level at this time t1. The selector SEL101 selects the enable signal REC_EN1. Therefore, the enable signal REC_EN3 of the source driver IC1 becomes the enable signal REC_EN1 of high level as mentioned above. Therefore, reception circuits RxDD1 to RxDD5 of the source driver IC1 enter the active state. On the other hand, the CHIP_{—}1 of source drivers IC2 to IC4 are in the low level. Therefore, the enable signal REC_EN3 of the source drivers IC2 to IC4 becomes the enable signal REC_EN2 of low level as mentioned above. Therefore, reception circuits RxDD1 to RxDD5 of the source drivers IC2 to IC4 are in the standby state.

The reception circuits RxDD0 of all source drivers receive a data signal DD0 of high level as a reset data RST at time t2. In a mini-LVDS interface, after the reception circuit Rx enters the active state, the data signal DD0 that is in the high level is set to the reset data RST for four cycles of the clock signal CLK (period T1). After receiving the reset data RST, the divide-by-4 frequency divider 22 outputs an internal operation clock signal at time t3 in each of all source drivers. Each source driver operates according to this internal operation clock signal.

Because the cascade signal DIO is in the high level, the source driver IC1 starts taking data of data signals DD0 to DD5 at timings of rising and falling edges of the clock signal CLK. Here, because the data is taken according to timings of rising and falling edges of the clock signal CLK as mentioned above, the data of eight bits is taken into the source driver in each one cycle of the internal operation clock for each data signal line.

Here, when (m×6)/8 pixel signal lines (m is a multiple of four) are driven for each one source driver, data taking of this one source driver is completed at the m-th edge timing of the clock signal CLK. Therefore, as shown in FIG. 3, the source driver IC1 takes data of data signals DD0 to DD5 at each edge of the clock signal CLK between the edge of the clock signal CLK at time t3 (the first edge) and the edge of the clock signal CLK at time t5 (the m-th edge).

The shift register 30 of the source driver IC1 counts the (m−3)-th edge of the clock signal CLK at time t4. Then, the shift register 30 informs the DOI signal generation circuit 23 that the count reaches the predetermined number. Then, the DOI signal generation circuit 23 of the source driver IC1 raises the cascade signal DOI to the high level at this timing. Note that the cascade signal DOI of this source driver IC1 is the cascade signal DIO of the source driver IC2.

At time t7 after one cycle of the internal operation clock from time t4, the DOI signal generation circuit 23 of the source driver IC1 lowers the cascade signal DOI to the low level. In addition, the REC_RSET signal of a pulse signal is generated by the enable control circuit 100 of the source driver IC1 according to this falling edge. The enable signal REC_EN1 of low level is output from the RS latching circuit RS101 according to this REC_RSET signal. Then, reception circuits RxCLK and RxDD0 of the source driver IC1 enter the standby state according to this enable signal REC_EN1 of low level. In addition, the enable signal REC_EN1 of low level is output from the selector SEL101 as the enable signal REC_EN3. Therefore, reception circuits RxDD1 to RxDD5 enter the standby state as well as the reception circuits RxCLK and RxDD0 mentioned above. Moreover, the divide-by-4 frequency divider 22 that generates the internal operation clock enters the standby state, too. Therefore, the source driver IC1 enters the standby state.

On the other hand, the source driver IC2 receives the cascade signal DIO of high level at time t4. In the enable control circuit 100 of the source driver IC2, the REC_SET2 signal of a pulse signal is generated according to the rising edge of this cascade signal DIO. The enable signal REC_EN2 of high level is output from the RS latching circuit RS102 according to this REC_SET2 signal. Here, the CHIP_{—}1 signal of the source driver IC2 is in the low level as state above. Therefore, the selector SEL101 selects the enable signal REC_EN2. In other words, REC_EN2=REC_EN3. Therefore, the enable signal REC_EN3 of the source driver IC2 also rises to the high level, and the reception circuits RxDD1 to RxDD5 of the source driver IC2 enter the active state.

After that, the source driver IC2 that receives the cascade signal DIO of high level starts to take data of data signals DD0 to DD5 at each edge of the clock signal CLK from the rising edge of the internal operation clock at time t6. Note that the edge of the clock signal CLK at time t6 is (m+1)-th edge. Therefore, the source driver IC2 takes data of data signals DD0 to DD5 at each edge of the clock signal CLK between the edge of the clock signal CLK at time t6 (the (m+1)-th edge) and the edge of the clock signal CLK at time t9 (the 2 m-th edge). At the same time, the shift register 30 of the source driver IC2 starts to count the edge of the clock signal CLK at time t6.

The shift register 30 of the source driver IC2 counts the (m⁻³)-th edge of the clock signal CLK at time t8. Then, the shift register 30 informs the DOI signal generation circuit 23 that the count reaches the predetermined number. Then, at this timing the DOI signal generation circuit 23 of the source driver IC2 raises the cascade signal DOI to the high level. Note that the cascade signal DOI of this source driver IC2 is the cascade signal DIO of the source driver IC3.

At time t11 after one cycle of the internal operation clock from time t8, the DOI signal generation circuit 23 of the source driver IC2 lowers the cascade signal DOI to the low level. In addition, the REC_RSET signal of a pulse signal is generated by the enable control circuit 100 of the source driver IC2 according to this falling edge. The enable signal REC_EN1 of low level is output from the RS latching circuit RS101 according to this REC_RSET signal. Moreover, the enable signal REC_EN2 of low level is output from the RS latching circuit RS102 with the REC_RSET signal. Then, reception circuits RxCLK and RxDD0 of the source driver IC2 enter the standby state according to this enable signal REC_EN1 of low level. Moreover, the enable signal REC_EN2 of low level is output from the selector SEL101 as the enable signal REC_EN3. Therefore, reception circuits RxDD1 to RxDD5 enter the standby state as well as the reception circuits RxCLK and RxDD0 mentioned above. Moreover, the divide-by-4 frequency divider 22 that generates the internal operation clock enters the standby state, too. Therefore, the source driver IC2 enters the standby state.

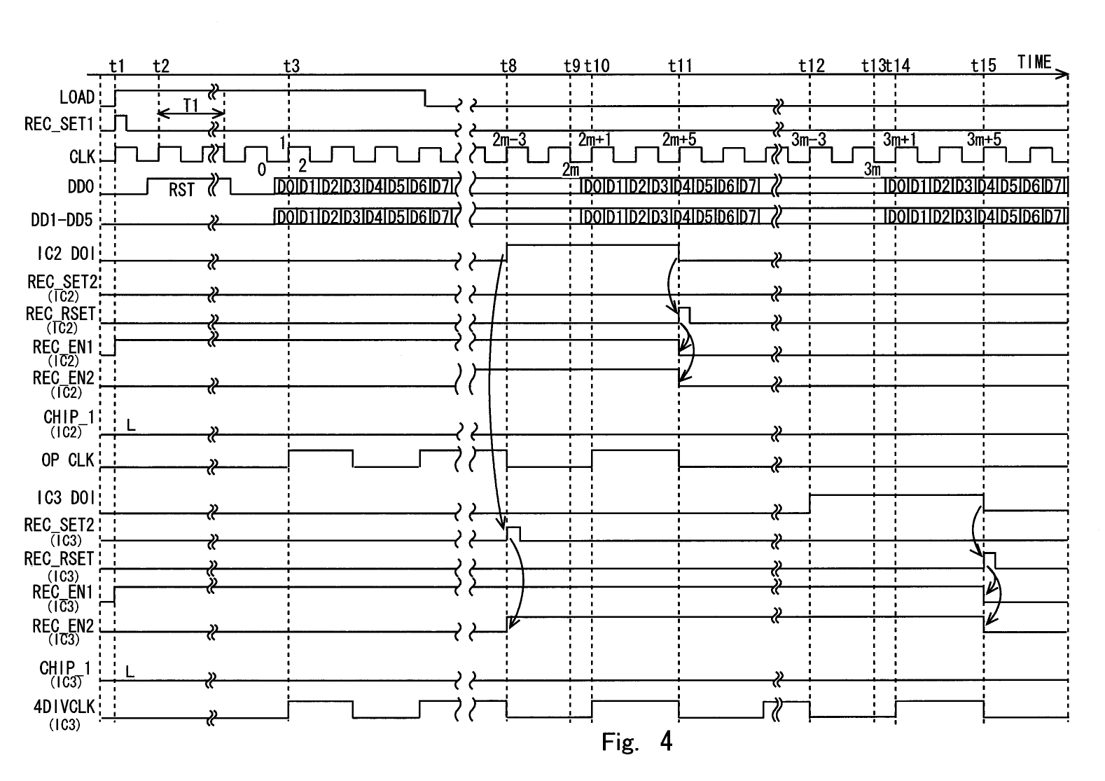

After this, source drivers IC3 and IC4 perform the similar operation as the source driver IC2. More specifically, as shown in FIG. 4 (and FIG. 3), the source driver IC3 receives the cascade signal DIO of high level at time t8. Then, in the enable control circuit 100 of the source driver IC3, the REC_SET2 signal of a pulse signal is generated according to the rising edge of this cascade signal DIO. The enable signal REC_EN2 of high level is output from the RS latching circuit RS102 according to this REC_SET2 signal. Because the CHIP_{—}1 signal of the source driver IC3 is in the low level, the selector SEL101 selects the enable signal REC_EN2. Therefore, REC_EN2=REC_EN3. Accordingly, the enable signal REC_EN3 of the source driver IC3 also rises to the high level, and the reception circuits RxDD1 to RxDD5 of the source driver IC3 enter the active state.

Further, in the source driver IC3 that receives the cascade signal DIO of high level starts to take data of data signals DD0 to DD5 at each edge of the clock signal CLK from the rising edge of the internal operation clock at time t10. Note that the edge of the clock signal CLK at time t10 is (2 m+1)-th edge. Therefore, the source driver IC3 takes data of data signals DD0 to DD5 at each edge of the clock signal CLK between the edge of the clock signal CLK at time t10 (the (2 m+1)-th edge) and the edge of the clock signal CLK at time t13 (the 3m-th edge). At the same time, the shift register 30 of the source driver IC3 starts to count the edge of the clock signal CLK at time t10.

The shift register 30 of the source driver IC3 counts the (m⁻³)-th edge of the clock signal CLK at time t12. Then, the shift register 30 informs the DOI signal generation circuit 23 that the count reaches the predetermined number. Then, at this timing the DOI signal generation circuit 23 of the source driver IC3 raises the cascade signal DOI to the high level. Note that the cascade signal DOI of this source driver IC3 is the cascade signal DIO of the source driver IC4.

At time t15 after one cycle of the internal operation clock from time t12, the DOI signal generation circuit 23 of the source driver IC3 raises the cascade signal DOI fall to the low level. In addition, the REC_RSET signal of a pulse signal is generated by the enable control circuit 100 of the source driver IC3 according to this falling edge. The enable signal REC_EN1 of low level is output from the RS latching circuit RS101 according to this REC_RSET signal. Moreover, the enable signal REC_EN2 of low level is output from the RS latching circuit RS102 with the REC_RSET signal. Then, reception circuits RxCLK and RxDD0 of the source driver IC3 enter the standby state according to this enable signal REC_EN1 of low level. Moreover, the enable signal REC_EN2 of low level is output from the selector SEL101 as the enable signal REC_EN3. Therefore, reception circuits RxDD1 to RxDD5 enter the standby state as well as the reception circuits RxCLK and RxDD0 mentioned above. Moreover, the divide-by-4 frequency divider 22 that generates the internal operation clock enters the standby state, too. Therefore, the source driver IC3 enters the standby state.

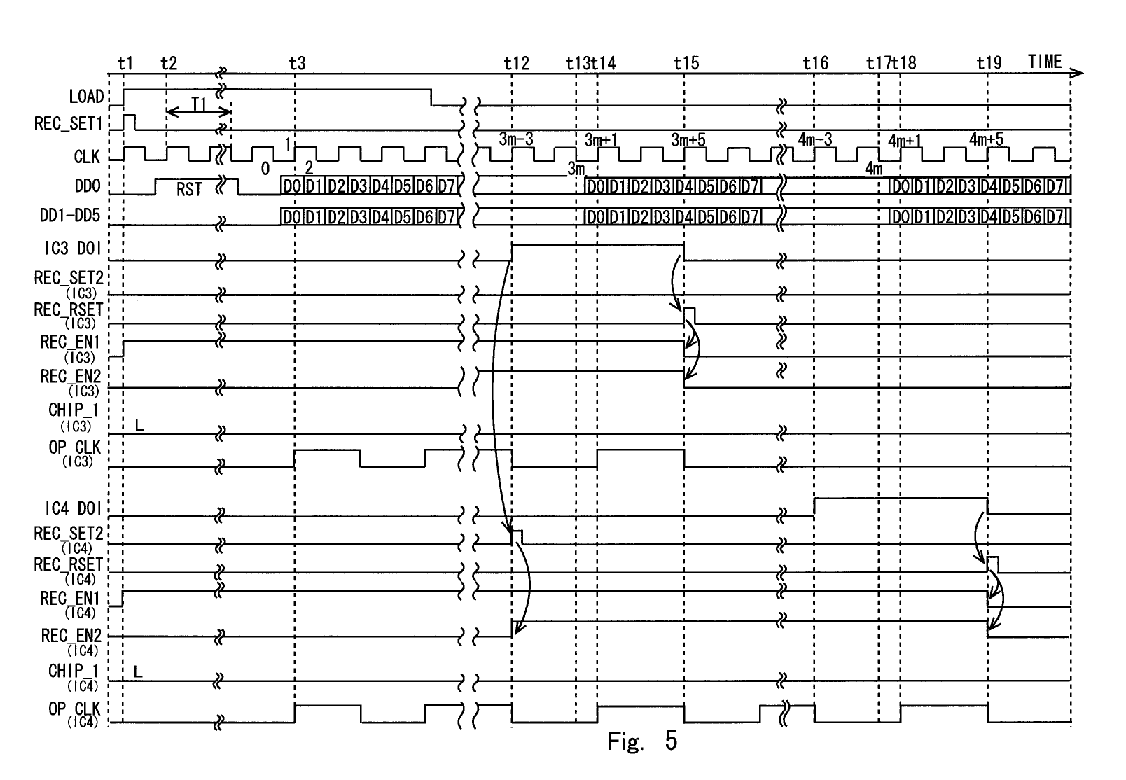

Further, as shown in FIG. 5 (and FIG. 4), the source driver IC4 receives the cascade signal DIO of high level at time t12. Then, in the enable control circuit 100 of the source driver IC4, the REC_SET2 signal of a pulse signal is generated according to the rising edge of this cascade signal DIO. The enable signal REC_EN2 of high level is output from the RS latching circuit RS102 according to this REC_SET2 signal. Because the CHIP_{—}1 signal of the source driver IC4 is in the low level, the selector SEL101 selects the enable signal REC_EN2. Therefore, REC_EN2=REC_EN3. Accordingly, the enable signal REC_EN3 of the source driver IC4 also rises to the high level, and the reception circuits RxDD1 to RxDD5 of the source driver IC4 enter the active state.

Further, in the source driver IC4 that receives the cascade signal DIO of high level starts to take data of data signals DD0 to DD5 at each edge of the clock signal CLK from the rising edge of the internal operation clock at time t14. Note that the edge of the clock signal CLK at time t14 is (3 m+1)-th edge. Therefore, the source driver IC4 takes data of data signals DD0 to DD5 at each edge of the clock signal CLK between the edge of the clock signal CLK at time t14 (the (3 m+1)-th edge) and the edge of the clock signal CLK at time t17 (the 4 m-th edge). At the same time, the shift register 30 of the source driver IC4 starts to count the edge of the clock signal CLK at time t14.

The shift register 30 of the source driver IC4 counts the (m−3)-th edge of the clock signal CLK at time t16. Then, the shift register 30 informs the DOI signal generation circuit 23 that the count reaches the predetermined number. Then, at this timing the DOI signal generation circuit 23 of the source driver IC4 raises the cascade signal DOI to the high level. Note that the cascade signal DOI of this source driver IC4 is the cascade signal DIO of a source driver of the subsequent stage.

At time t19 after one cycle of the internal operation clock from time t16, the DOI signal generation circuit 23 of the source driver IC4 lowers the cascade signal DOI to the low level. In addition, the REC_RSET signal of a pulse signal is generated by the enable control circuit 100 of the source driver IC4 according to this falling edge. The enable signal REC_EN1 of low level is output from the RS latching circuit RS101 according to this REC_RSET signal. Moreover, the enable signal REC_EN2 of low level is output from the RS latching circuit RS102 with the REC_RSET signal. Then, reception circuits RxCLK and RxDD0 of the source driver IC4 enter the standby state according to this enable signal REC_EN1 of low level. Moreover, the enable signal REC_EN2 of low level is output from the selector SEL101 as the enable signal REC_EN3. Therefore, reception circuits RxDD1 to RxDD5 enter the standby state as well as the reception circuits RxCLK and RxDD0 mentioned above. Moreover, the divide-by-4 frequency divider 22 that generates the internal operation clock enters the standby state, too. Therefore, the source driver IC4 enters the standby state.

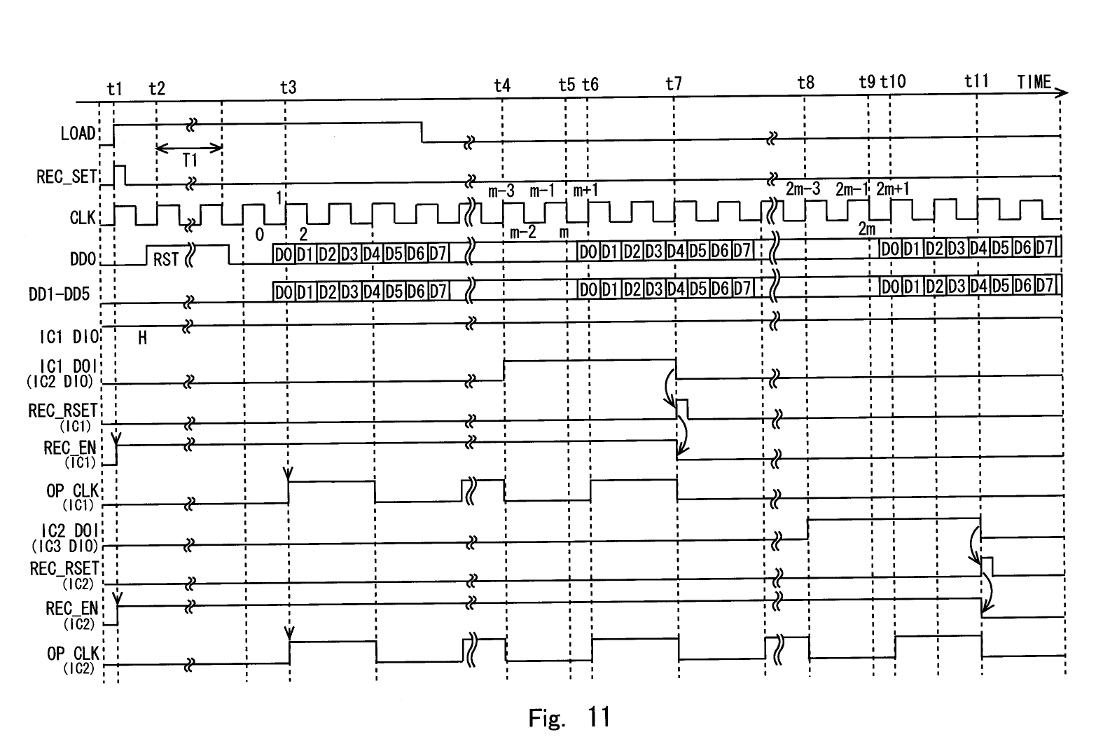

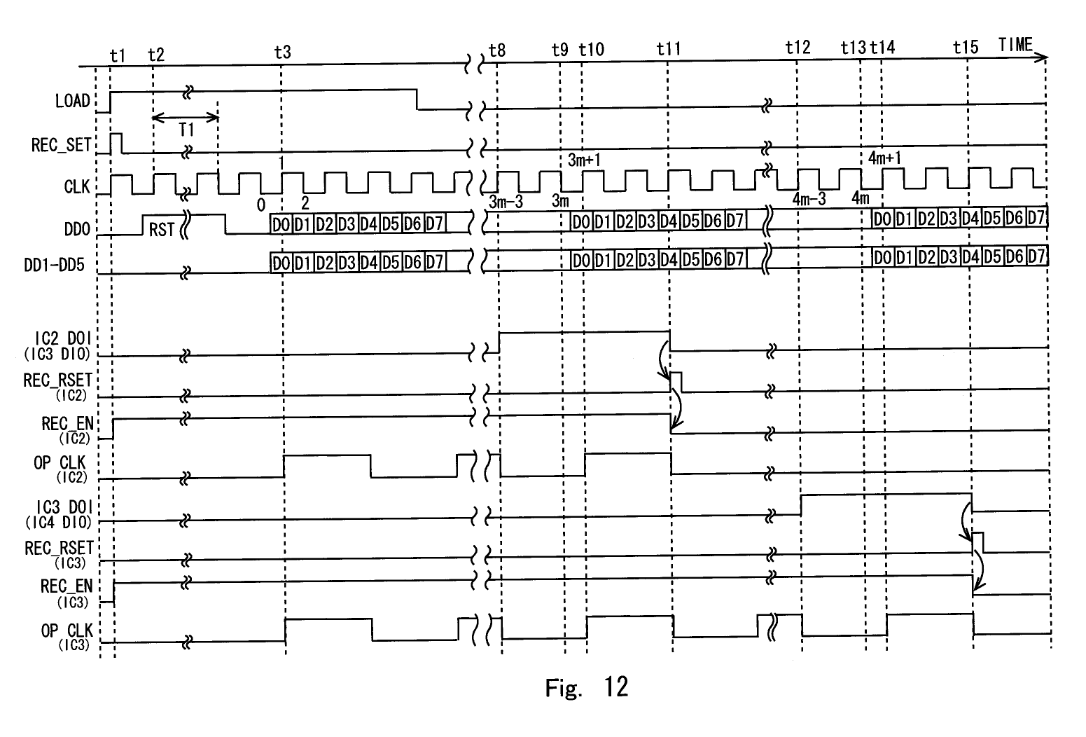

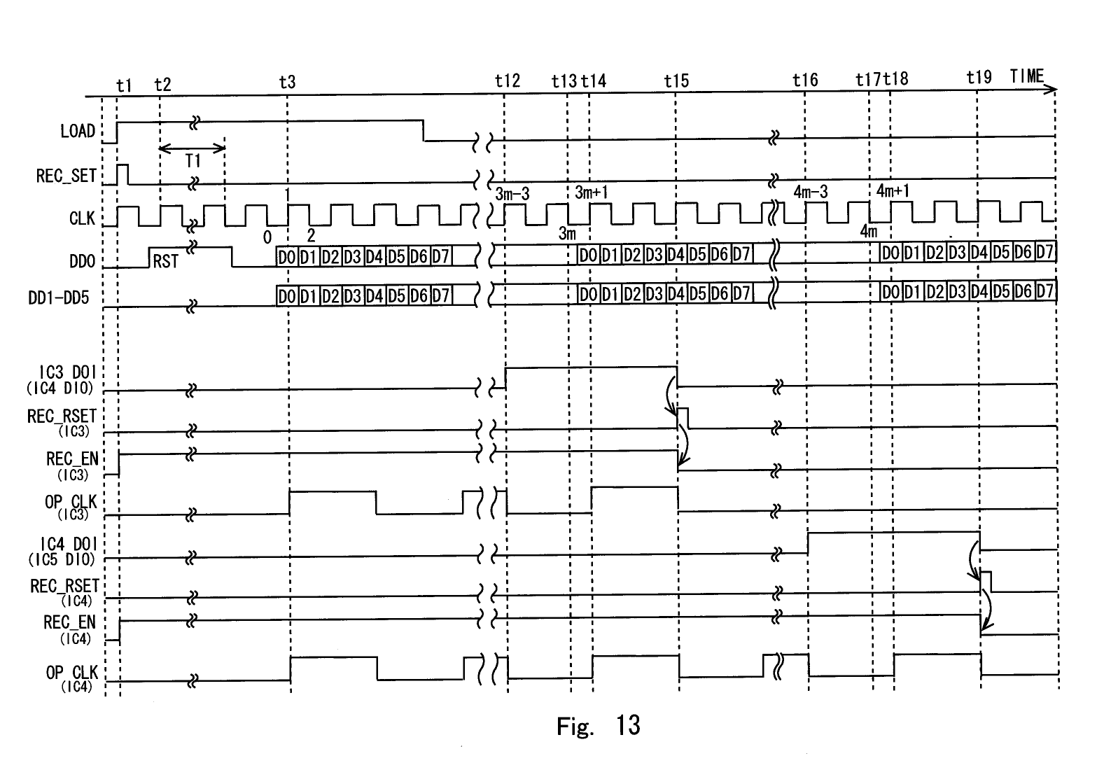

Here, as shown in FIG. 11 to FIG. 13, in the plane display device 1 of a related art, reception circuits RxCLK and RxDD0 to RxDD5 of the source drivers IC1 to IC4 are in the active state from time t1. This is due to the fact that reception circuits RxDD0 and RxCLK which receive the clock signal CLK and the reset data RST of each of source drivers enter the active state at time t1 in the mini-LVDS interface standard.

However, source drivers IC1 to IC4 need not make reception circuits RxDD1 to RxDD5 active other than reception circuits RxDD0 and RxCLK until the cascade signal DIO of high level is received. Nevertheless, in the plane display device 1 of the related art, reception circuits RxDD1 to RxDD5 are continuously set to the active state from time t1. Therefore, in reception circuits RxDD1 to RxDD5, unnecessary electric power is consumed.

However, in source drivers of the plane display device in this exemplary embodiment, reception circuits RxDD1 to RxDD5 can be set to the standby state until the cascade signal DIO of high level is received by each of source drivers because each of source drivers has the enable control circuit 100 that has the configuration as described above. Therefore, the power consumption of the source driver in this exemplary embodiment can be decreased compared with that of the related art.

Note that the present invention is not limited to the above exemplary embodiment but can be modified as appropriate within the scope of the present invention. For example, the interface between the transmitting circuit and the reception circuit is not limited to the mini-LVDS. For example, in the above-mentioned exemplary embodiment, the reception circuit RxDD0 is in the active state from time t1 in all source drivers since the reception circuit RxDD0 receives the reset data RST. However, the reception circuit RxDD0 may enter the standby state until the cascade signal DIO of high level is received as is similar to reception circuits RxDD1 to RxDD5 when it is not required to comply with such protocol.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A source driver having a cascade connection configuration that drives signal lines of a display device according to a plurality of signals transmitted by a mini-LVDS interface from a controller during a predetermined period corresponding to a cascade signal received from a preceding stage, the source driver comprising:
a first reception circuit that receives a first signal of the plurality of signals;
a second reception circuit that receives a second signal of the plurality of signals; and
an enable control circuit that controls each of the first reception circuit and the second reception circuit to one of an active state and a standby state;
wherein the enable control circuit sets the second reception circuit to the active state according to the cascade signal received from the preceding stage, and sets the first and second reception circuits to the standby state according to a cascade signal output by the source driver to a subsequent stage.

2. The source driver according to claim 1, wherein
the enable control circuit sets the first reception circuit to the active state according to a start signal, when the start signal to start the source driver is received from the controller.

3. The source driver according to claim 2, wherein
the start signal is a strobe signal output for every one horizontal period.

4. The source driver according to claim 1, wherein
the first signal that the first reception circuit receives is a clock signal to generate an operation clock of the source driver.

5. The source driver according to claim 1, wherein
the first signal that the first reception circuit receives comprises a reset data signal to reset the source driver.

6. The source driver according to claim 1, further comprising:
a cascade signal generation circuit that generates a cascade signal that the source driver outputs to the subsequent stage after a predetermined period from receiving a cascade signal from the preceding stage.

7. The source driver according to claim 1, wherein
the enable control circuit comprises first and second RS latching circuit and selector,
the first RS latching circuit generates a first enable signal according to a first pulse signal and a second pulse signal, the first pulse signal supplied to a set terminal and corresponding to the start signal, the second pulse signal supplied to a reset terminal and corresponding to a cascade signal that the cascade signal generation circuit generates and outputs to the subsequent stage,
the second RS latching circuit generates a second enable signal according to a third pulse signal and the second pulse signal, the third pulse signal supplied to a set terminal and corresponding to the cascade signal received from the preceding stage, the second pulse signal supplied to a reset terminal,
the selector selects one of the first and second enable signals according to a select signal based on the start signal and the cascade signal received from the preceding stage and outputs the selected signal as a third enable signal,
the first enable signal controls the first reception circuit to one of the active state and the standby state, and
the third enable signal controls the second reception circuit to one of the active state and the standby state.

8. A method of controlling a source driver that has a cascade connection configuration and drives signal lines of a display device according to a plurality of signals transmitted by a mini-LVDS interface from a controller during a predetermined period when a cascade signal received from a preceding stage is active, the source driver comprising:
a first reception circuit that receives a first signal of the plurality of signals and a second reception circuit that receives a second signal of the plurality of signals, the method comprising:
setting the second reception circuit to an active state according to the cascade signal received from the preceding stage; and
setting the first and second reception circuits to the standby state according to a cascade signal output by the source driver to a subsequent stage.
